(19) United States
(12) Patent Application Publication
(10) Pub. No.: US 2017/0016425 A1
(43) Pub. Date: Jan. 19, 2017

(54) POWER GENERATION SYSTEM

(71) Applicants: WEN-CHIEH CHEN, TAIPEI CITY (TW); PAY COME CO., LTD, NEW TAIPEI CITY (TW)

(72) Inventor: WEN-CHIEH CHEN, TAIPEI CITY (TW)

(21) Appl. No.: 15/212,056

(22) Filed: Jul. 15, 2016

(30) Foreign Application Priority Data
Jul. 17, 2015 (TW) 104123225

(51) Int. Cl. F03B 13/26; F03G 3/04; H02K 7/18

(52) U.S. Cl. CPC F03B 13/26; H02K 7/1823; F03G 3/04

(57) ABSTRACT

A power generation system is provided. The power generation system includes a floating body, a transmission device, a transportation tank, an upper container, and a power generator unit. The transmission device is driven by a tidal force or a buoyant force through the floating body to lift up the transportation tank to a first position, which is near to the upper container, or to lower the transportation tank down to a second position, which is at a lower level than that of the electric motor to recycle the solid particles. The upper container for carrying a plurality of solid particles is disposed at a higher level than that of the power generator unit, and is used to store and release the solid particles to drive the power generator unit to generate electric power.

### BACKGROUND OF THE INVENTION

1. Field of the Invention

The instant disclosure relates to a power generation system; in particular, to a power generation system for converting the tidal force or buoyant force to electrical power.

2. Description of Related Art

Due to earth's limited resources, green and renewable energy such as solar, wind, and water power generation has attracted great attention. However, green energy is limited by environmental factors and cannot provide steady electric power. For example, solar power cannot be generated at night and water power cannot be generated without water resources. In addition, wind power is easily affected by weather or seasonal conditions so that the electric supply is not steady enough. Accordingly, searching for another green energy to provide steady electric power has become a current issue in the industry.

### SUMMARY OF THE INVENTION

The object of the instant disclosure is to provide a power generation system for converting the tidal force or buoyant force to potential power for driving an electric motor and generating electric power.

In order to achieve the aforementioned objects, according to an embodiment of the instant disclosure, a power generation system includes a floating body, a transmission device, a transportation tank, an upper container, and a power generator unit. The floating body is driven by a tidal force to move upward or downward. The transmission device is connected to the floating body, and the transportation tank for transporting a plurality of solid particles is linked up with the transmission device. The upper container is arranged near to a first position. When the floating body moves upward or downward, the transmission device is driven to lift the transportation tank up to the first position so that the solid particles are transported to and stored in the upper container or the transmission device is driven to lower the transportation tank down to a second position to recycle the solid particles. The power generator unit is arranged under the upper container. When the upper container releases the solid particles stored therein, the power generator unit is driven to generate electric power.

According to another embodiment of the instant disclosure, a power generation system is provided. The power generation system includes a floating body, a transmission device, a transportation tank, an upper container, and a power generator unit. The floating body floating on the water is driven by a buoyant force to move up and down. The transmission device is connected to the floating body, and the transportation tank for transporting a plurality of solid particles is linked up with the transmission device. The upper container is arranged near to a first position. When the floating body moves up and down, the transmission device is driven to lift the transportation tank up to the first position so that the solid particles are transported to and stored in the upper container or the transmission device is driven to lower the transportation tank down to a second position for receiving the solid particles. The power generator unit is arranged under the upper container. When the upper container releases the solid particles stored therein, the power generator unit is driven by the released solid particles and generates electric power.

In the power generation system provided in the instant disclosure, the tidal force or the buoyant force is converted to the potential energy of the solid particles through the floating body and the transmission device, and the pull of gravity on the solid particles is used to drive the power generator unit to generate electric power. As such, the power generation system provided in the instant disclosure can supply steady and environmentally friendly electric power by using green energy.

In order to further the understanding regarding the instant disclosure, the following embodiments are provided along with illustrations to facilitate the disclosure of the instant disclosure.

### BRIEF DESCRIPTION OF THE DRAWINGS

FIG. 1A is a schematic diagram of a power generation system at low tide according to an embodiment of the instant disclosure;

FIG. 1B is a schematic diagram of the power generation system at high tide according to an embodiment of the instant disclosure;

FIG. 2 is a schematic diagram of a power generator unit according to another embodiment of the instant disclosure;

FIG. 3 is a schematic diagram illustrating the solid particles transported to the upper container according to an embodiment of the instant disclosure;

FIG. 4 is a schematic diagram illustrating the solid particles poured into each of the cup-shaped blades according to an embodiment of the instant disclosure;

FIG. 5 is a schematic diagram illustrating the solid particles transferred to the lower container according to an embodiment of the instant disclosure;

FIG. 6 is a schematic diagram of the power generation system recovered to an initial condition of the instant disclosure;

FIG. 7A is a schematic diagram of a power generation system at high tide according to another embodiment of the instant disclosure;

FIG. 7B is a schematic diagram of the power generation system shown in FIG. 7A at low tide according to the embodiment of the instant disclosure;

FIG. 8A is a schematic diagram of a power generation system at low tide according to another embodiment of the instant disclosure;

FIG. 8B is a schematic diagram of the power generation system shown in FIG. 8A at high tide according to the embodiment of the instant disclosure;

FIG. 9A is a schematic diagram of a power generation system according to another embodiment of the instant disclosure; and

FIG. 9B is a schematic diagram of the power generation system according to the embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

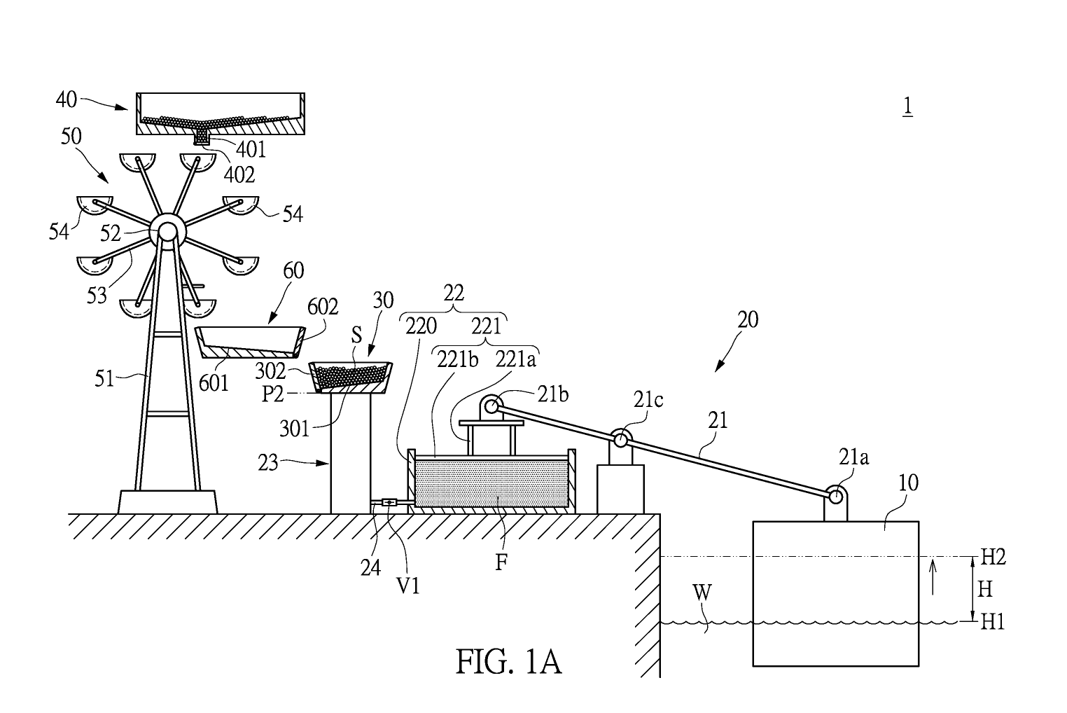

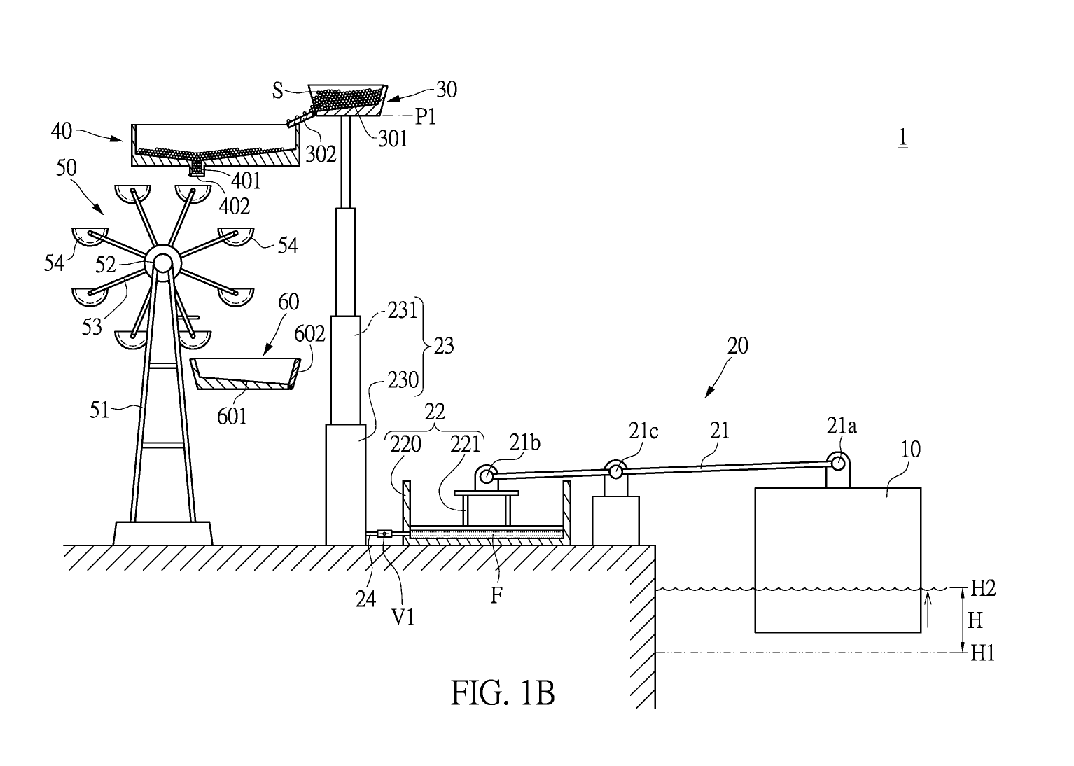

Please refer to FIG. 1A and FIG. 1B. FIG. 1A shows a schematic diagram of a power generation system at low tide according to a first embodiment of the instant disclosure, and FIG. 1B shows a schematic diagram of the power generation system at high tide according to a first embodiment of the instant disclosure.

The power generation system 1 includes a floating body 10, a transmission device 20, a transportation tank 30, an upper container 40 and a power generator unit 50.

The floating body 10 floats on the water or on the sea and moves up and down due to a tidal force or a buoyant force. In the instant embodiment, the floating body 10 is placed on the sea surface. The sea level is located at a lowest position H1 at low tide, and the sea level is located at a highest position H2 at high tide. The height difference between the lowest position H1 and the highest position H2 is the tidal difference H. That is, the height position of the floating body 10 varies with the conditions of low tide and high tide. Similarly, under the condition that the floating body 10 floats on the water, the height position of the floating body 10 varies with the water level. In the instant embodiment, the maximum difference between the height position of the floating body 10 at low tide and high tide is the tidal difference H.

The transmission device 20 is connected to the floating body to convert the tidal force to potential energy. Specifically, the transmission device 20 of the instant embodiment includes a first hydraulic unit 22, a second hydraulic unit 23, a connecting pipe 24 and a lever 21. The first hydraulic unit 22 and the second hydraulic unit 23 are in fluid communication with each other through the connecting pipe 24.

The first hydraulic unit 22 includes a first reservoir 220 for storing a working fluid F, and a first piston 221 arranged in the first reservoir 220. In one embodiment, the first piston 221 has a force reception portion 221a and a force application portion 221b. One side of the force application portion 221b is in contact with the working fluid F, and the other opposite side of the force application portion 221b is physically connected to the force reception portion 221a. In addition, the first hydraulic unit 22 further includes a stopping member (not shown in FIG. 1A) to restrict the lowest position of the first piston 221.

Please refer to FIG. 1B. The second hydraulic unit 23 includes a second reservoir 230 and a second piston 231 arranged in the second reservoir 230. The first reservoir 220 and the second reservoir 230 are in fluid communication with each other to allow the working fluid F to flow between the first hydraulic unit 22 and the second hydraulic unit 23.

As shown in FIG. 1A and FIG. 1B, a control valve V1 is disposed on the connecting pipe 24. When the working fluid F is squeezed into the second hydraulic unit 23 due to the pressure applied on the first piston 221 of the first hydraulic unit 22, the control valve V1 can be switch off to prevent the working fluid F from flowing back to the first hydraulic unit 22.

The lever 21 includes a first end 21a, a second end 21b opposite to the first end 21a, and a pivot point 21c located between the first and second ends 21a, 21b. In the instant embodiment, the first end 21a of the lever 21 is movably connected to the floating body 10, and the second end 21b is pivotally connected to the first piston 221. Please refer to FIG. 1A and FIG. 1B. During the low tide period or the high tide period, the tidal force drives the floating body 10 to move up or down, such that the first end 21a and the second end 21b of the lever 21 rotate clockwise or counterclockwise relative to the pivot point 21c. In one embodiment, the first end 21a of the lever 21 is pivotally connected to the floating body 10. In another embodiment, the first end 21a is connected to the floating body 10 through a rope to prevent the fluctuation of the transportation tank 30 due to the waves.

Subsequently, the operation of the transmission device 20 in conjunction with the tidal force will be explained in details in the following description. Please refer to FIG. 1A. During the high tide period, the sea level gradually rises from the lowest position H1 to the highest position H2 to cause a corresponding upward movement of the floating body 10, and the first end 21a and the second end 21b of the lever 21 are driven to rotate counterclockwise relative to the pivot point 21c. Meanwhile, the second end 21b of the lever 21 pushes down the first piston 221 so that the working fluid F in the first reservoir 220 is squeezed into the second reservoir 230 through the connecting pipe 24. The working fluid F flowing into the second reservoir 230 pushes up the second piston 231. After the second piston 231 is pushed up to a highest position, the control valve can be switched off to prevent the working fluid F from flowing back into the first hydraulic unit 22.

During the low tide period, the sea level gradually drops from the highest position H2 down to the lowest position H1 to cause corresponding downward movement of the floating body 10, and the first end 21a and the second end 21b of the lever 21 are driven to rotate clockwise relative to the pivot point 21c so that the first piston 221 is pulled up. Because the fluid level of the working fluid F in the second hydraulic unit 23 is higher than that of the working fluid F in the first hydraulic unit 22, the working fluid F in the second hydraulic unit 23 can flow back to the first hydraulic unit 22 due to the connected vessels principle, vacuum, and the pull of gravity on the transportation tank 30, and the second piston 231 descends down to a lowest position.

Accordingly, the tidal force can be converted to the potential energy through the floating body 10 and transmission device 20 so that an article can be lifted up to a higher position.

Please refer to FIG. 1A. The transportation tank 30 for containing a plurality of solid particles S is disposed on the top of the second piston 231. The solid particles S can be iron sand or gravel.

Please refer to FIG. 1B. When the floating body 10 moves upward due to the tidal force, the transportation tank 30 driven by the transmission device 20 is lifted up to a first position P1. On the contrary, when the floating body 10 moves downward due to the tidal force, the transportation tank 30 driven by the transmission device 20 descends down to a second position P2 to receive the solid particles S. The cycling process of the solid particles S in the transportation tank 30 will be explained in detail in the following description.

After the solid particles S are transported by the transportation tank 30 to the first position P1, the solid particles S are transferred to the upper container 40 for temporary storage. In one embodiment, the transportation tank 30 includes an inclined bottom 301 and an active gate 302 for opening toward the upper container 40.

Furthermore, the upper container 40 is arranged immediately adjacent to the first position P1, and the elevational position of the upper container 40 with respect to the ground level is lower than the first position P1 with respect to the ground level. When the transportation tank 30 is lifted up to the first position P1, the active gate 302 can be opened so that the solid particles S in the transportation tank 30 slide along the inclined bottom 301 and fall into the upper container 40. In another embodiment, the power generation system can include a delivery pipe (not shown) so that the solid particles S can fall into the upper container 40 through the delivery pipe.

At least one power generator unit 50 is arranged under the upper container 40. When the solid particles S are released from the upper container 40, the pull of gravity on the solid particles S can drive the power generator unit 50 to generate electric power. Specifically, in the instant embodiment, the upper container 40 includes a discharge opening 401 at the bottom of the upper container 40 and a movable door 402 disposed corresponding to the discharge opening 401 for releasing the solid particles S stored in the upper container 40.

Please refer to FIG. 1B again. Furthermore, the power generator unit 50 includes a base 51, an electric motor 52, a plurality of arms 53, and a plurality of cup-shaped blades 54. The electric motor 52 is disposed on the base 51, and the arms 53 are connected to the electric motor 52 to drive the rotation of the electric motor 52. The elevational position of the electric motor 52 with respect to the ground level is higher than the second position P2. The cup-shaped blades 54 are respectively connected to the ends of the arms 53 for carrying the released solid particles S from the upper container 40.

When each of the cup-shaped blades 54 is rotated to the position in alignment with the discharge opening 401, the movable door 402 of the upper container 40 can open so that the solid particles fall into the cup-shaped blade 54 under the discharge opening 401. Subsequently, the gravity of the solid particles carried by the cup-shaped blade 54 can drive the electric motor 52 to rotate through the corresponding arm 53 and generate electric power. In one embodiment, the movable door 402 on the bottom of the upper container 40 is intermittently opened and closed so that the solid particles S are carried on each of the cup-shaped blades 54 sequentially passing below the discharge opening 401.

To be more specific, the upper container 40 can include a sensor (not shown) and a switching unit (not shown) electrically connected to the sensor.

The sensor can detect whether each of the cup-shaped blades 54 reaches a predetermined position under the movable door 402, and the switching unit is used to control the open and close state of the movable door 402 and the flow of the solid particles S.

The flow of the solid particles S is dependent on the aperture of the discharge opening 401, and the switching unit controls the aperture of the discharge opening 401 through the control of the movable door 402 so that the flow of the solid particles S can be controlled, thereby controlling the rotational speed of the electric motor 52 and the electric power produced per unit time. The flow of the solid particles S means the total weight of the solid particles S passing through the discharge opening 401 per unit time.

Accordingly, in the power generation system provided in the embodiment of the instant disclosure, the output electric power can be controlled by adjusting the flow of the solid particles S according to the electricity consumption at different time intervals so as to improve the energy efficiency.

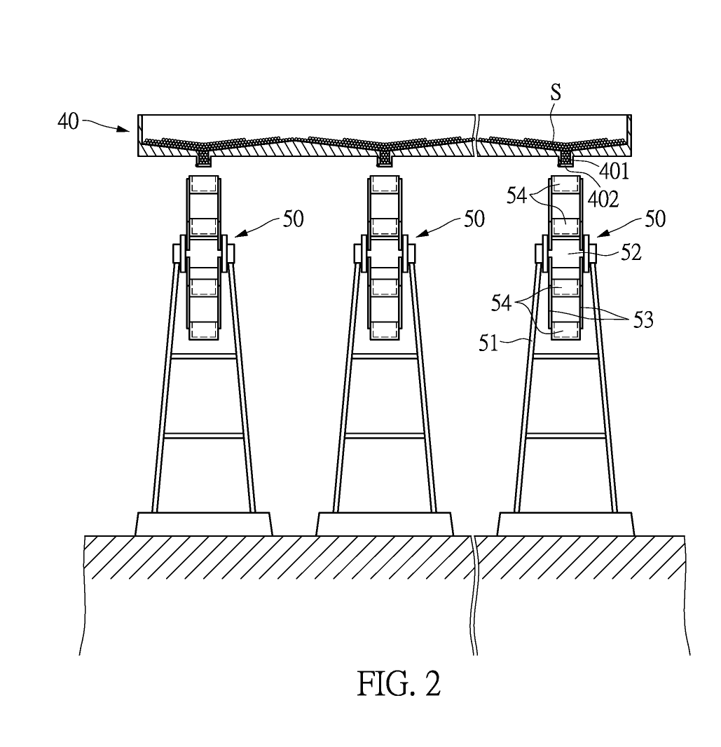

Please refer to FIG. 2. FIG. 2 is a schematic diagram of a power generator unit according to another embodiment of the instant disclosure. In the embodiment, the power generation system 1 further includes more than one power generator unit 50 arranged under the upper container 40 so that more electric power can be produced at the same time. Accordingly, the upper container 40 of the instant embodiment includes a plurality of discharge openings 401 and movable doors 402, which respectively correspond to the positions of the power generator units 50. Additionally, by individually controlling the open and close state of the different movable doors 402, the power generator units 50 are able to be operated in different modes. That is, the power generator units 50 can be operated independently. In one embodiment, only some of the power generator units 50 are in operation mode and the others are in standby mode. In another embodiment, all of the power generator units 50 are in operation mode or in standby mode.

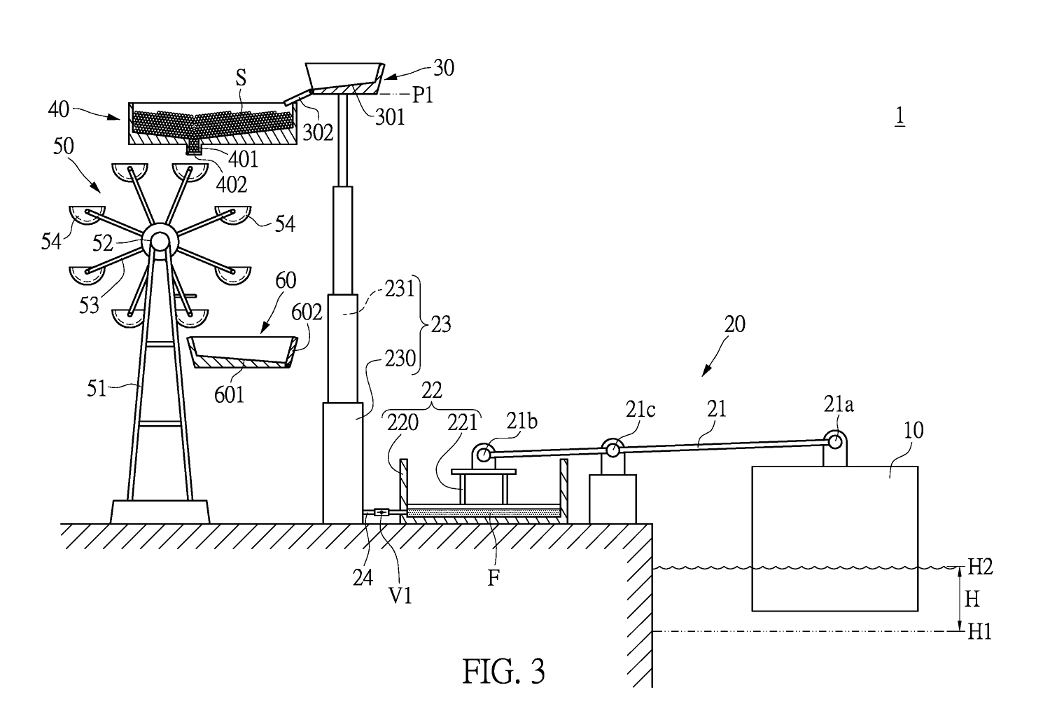

Herein, the electric power generation process of the power generation system of the instant disclosure by using the tidal force or the buoyant force is described in detail. Please refer to FIG. 3, which is a schematic diagram illustrating the solid particles transported to the upper container according to an embodiment of the instant disclosure.

During high tide, the floating body 10 moves upward and drives the transmission device 20 to lift up the transportation tank 30 containing the solid particles S to the first position P1. After the transportation tank 30 reaches the first position P1, the active gate 302 is opened so that the solid particles S contained in the transportation tank 30 slide toward and fall into the upper container 40.

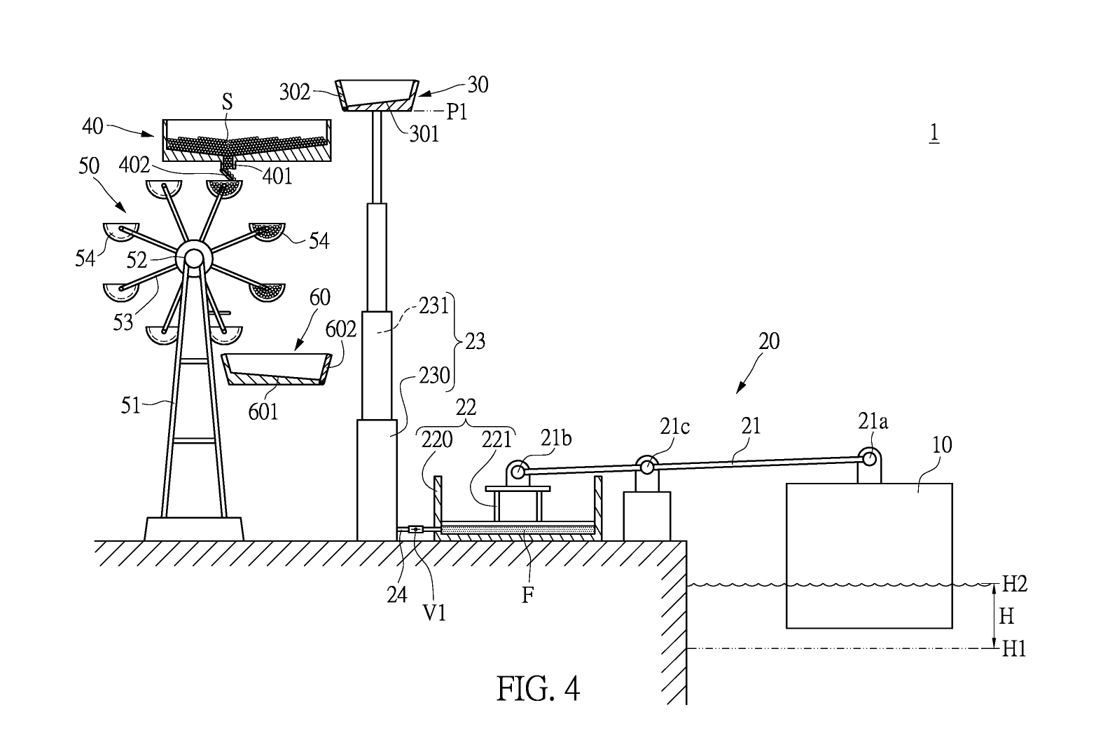

Please refer to FIG. 4, which is a schematic diagram illustrating the solid particles poured into each of the cup-shaped blades according to an embodiment of the instant disclosure. The movable door 402 arranged at the bottom of the upper container 40 is opened when each of the cup-shaped blades 54 of the power generator unit 50 passes below the upper container 40. The solid particles S stored in the upper container 40 are poured into each of the cup-shaped blades 54 from the discharge opening 401. When the weight of the cup-shaped blades 54 with the carried solid particles S is over a predetermined value, the gravitational torque produced by the weight of the cup-shaped blade 54 with the carried solid particles S drives the cup-shaped blade 54 to rotate relative to an axis so that the electric motor 52 is also driven through the arm 53 to rotate and produce electric power.

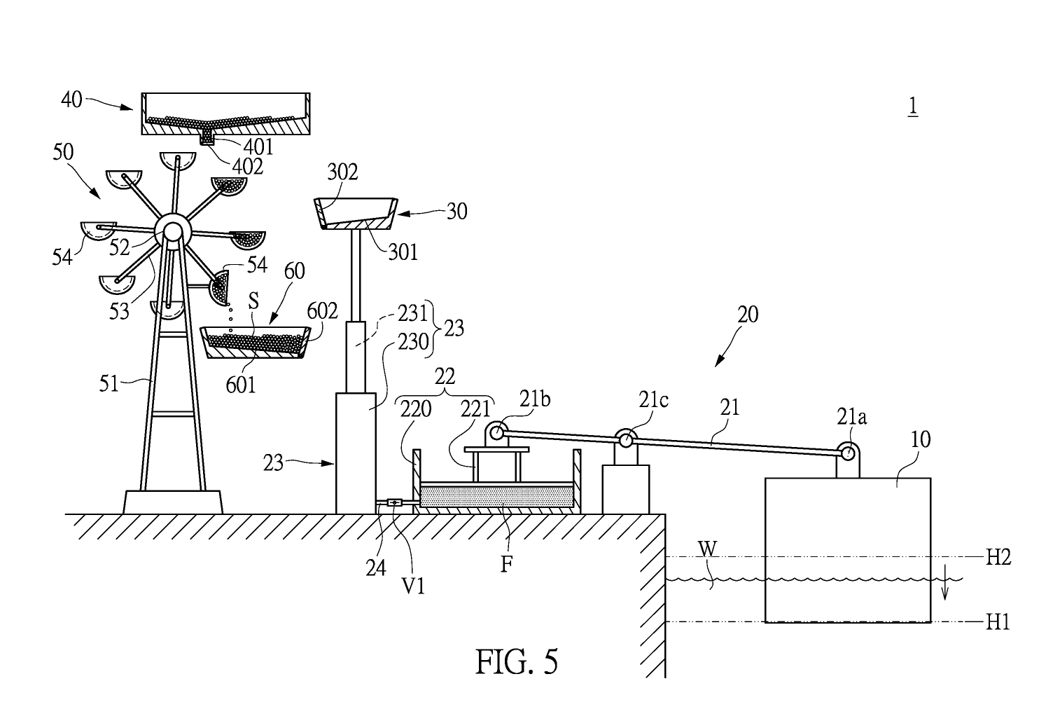

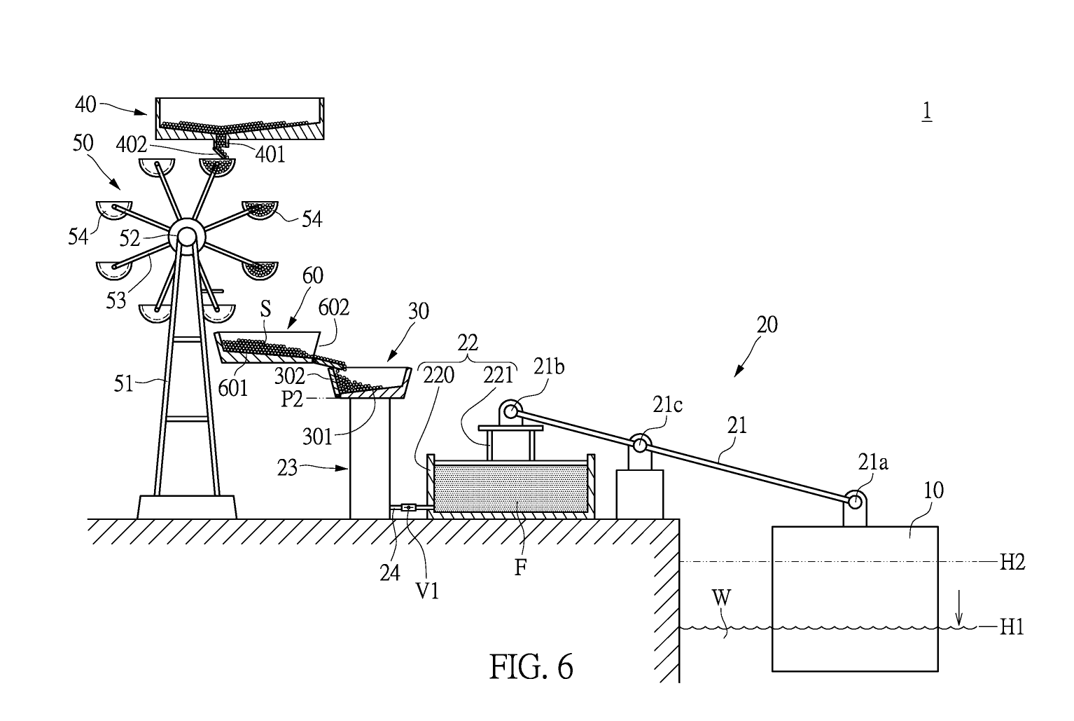

Please refer to FIG. 5 and FIG. 6. FIG. 5 is a schematic diagram illustrating the solid particles transferred to the lower container according to an embodiment of the instant disclosure, and FIG. 6 is a schematic diagram of the power generation system recovered to an initial condition of the instant disclosure. After the cup-shaped blade 54 with the carried solid particles rotates to a preset position, the carried solid particles S are recycled to the transportation tank 30. The preset position can be the lowest position of the cup-shaped blades 54 during the rotation.

Please refer to FIG. 5. In the embodiment of the instant disclosure, the power generation system 1 further includes a lower container 60. The elevational position of the lower container 60 with respect to the ground level is lower than that of the electric motor 52 with respect to the ground level. Furthermore, the elevational position of the lower container 60 is higher than the second position P2 to temporarily store the solid particles S recycled from each of the cup-shaped blades 54. Specifically, the solid particles S carried by each of the cup-shaped blades 54 can be released by using a releasing member (not shown) and enter into the lower container 60. The releasing member can be a valve (not shown) arranged in the cup-shaped blade 54 or a lever shown in FIG. 5 which allows the cup-shaped blades 54 to be inclined so that the carried solid particles S are poured into the lower container 60.

Please refer to FIG. 6. The lower container 60 includes a sloping bottom surface 601 and a movable gate 602 facing toward the transportation tank 30. During the low tide period, the floating body 10 moves downward, and the control valve V1 is turned on so that the working fluid F in the second reservoir 230 is allowed to flow back to the first reservoir 220 by the vacuum effect and the weight of the transportation tank 30, thereby the transportation tank 30 descends down to the second position P2. After the transportation tank 30 is located at the second position P2, the movable gate 602 of the lower container 60 is opened so that the solid particles S in the lower container 60 can be poured into the transportation tank 30 until the next high tide period. The processes shown in FIG. 3 to FIG. 6 are repeated during each of tidal cycles.

In the instant embodiment, the solid particles S can be stored in the lower container 60 until the transportation tank 30 descends down to the second position P2.

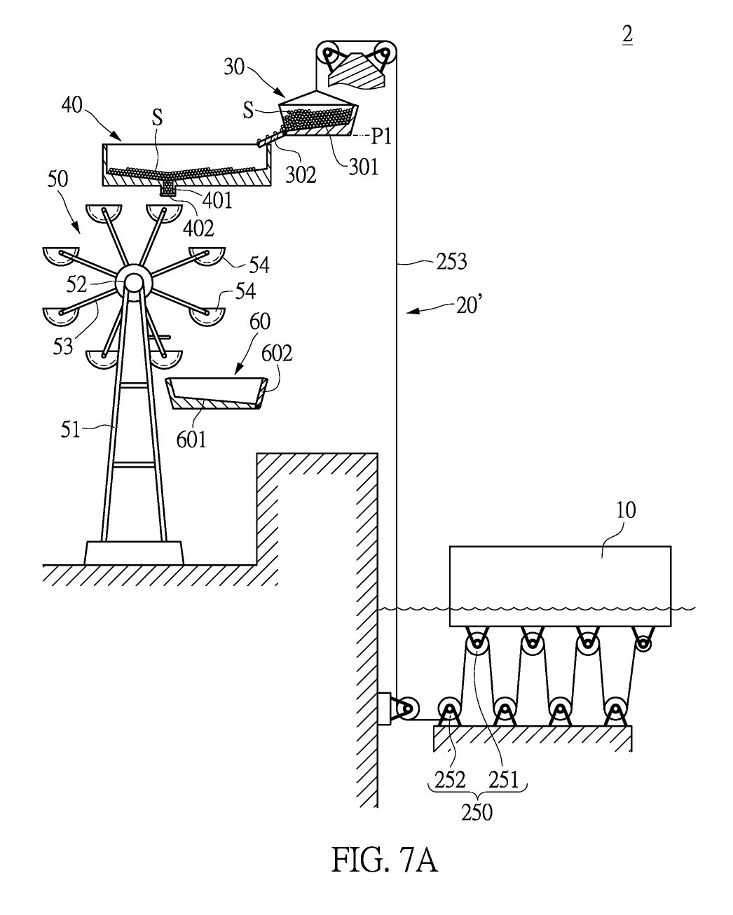

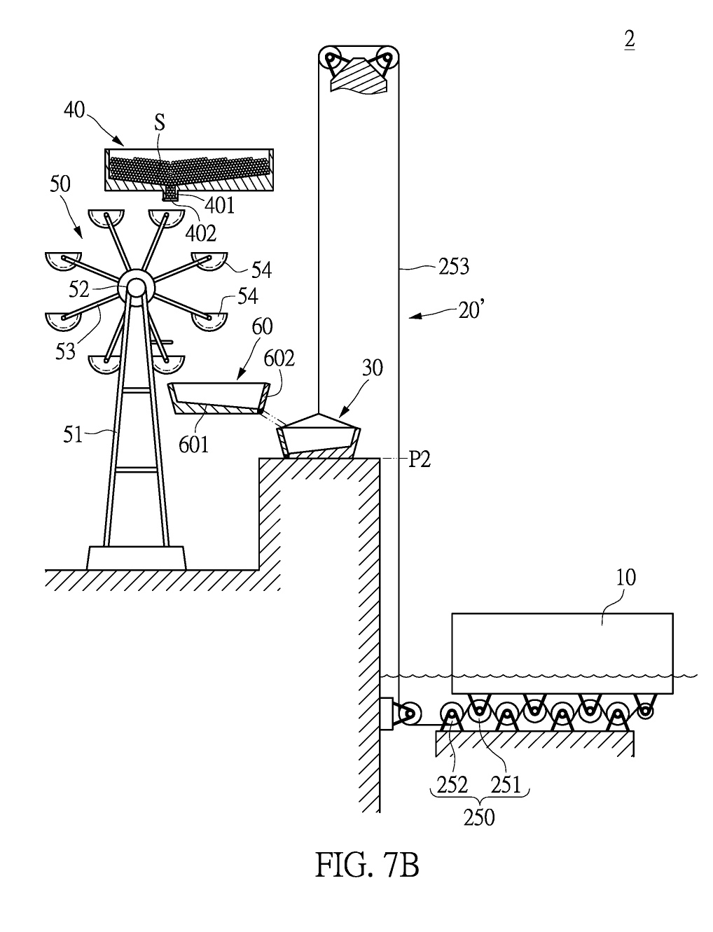

Please refer to FIG. 7A and FIG. 7B. FIG. 7A is a schematic diagram of a power generation system in high tide according to another embodiment of the instant disclosure, and FIG. 7B is a schematic diagram of the power generation system shown in FIG. 7A in low tide according to the embodiment of the instant disclosure.

As shown in FIG. 7A, the power generation system 2 includes a floating body 10, the transmission device 20′, a transportation tank 30, an upper container 40, and the power generator unit 50. The same numerical references are given to the same elements as those shown in FIG. 1A.

In the instant embodiment, the transmission device 20′ includes a pulley assembly 250 and a drive element 253. The pulley assembly 250 includes a plurality of pulleys, and the drive element 253 is arranged to revolve around the pulleys and connected between the transportation tank 30 and the floating body 10.

Specifically, in the instant embodiment, a plurality of movable pulleys 251 is arranged at the bottom of the floating body 10, and a plurality of fixed pulleys 252 is configured to a rigid wall (not labeled). The drive element 253, such as a rope, cable, belt, steel wire or steel cable, can be wound around the movable pulleys 251 and fixed pulleys 252 and suspends the transportation tank 30. However, the selections and arrangements of the pulley assembly 250 are not limited to the example provided herein, and the other elements also can be used to achieve the same results.

Referring to FIG. 7A, approaching high tide, the floating body 10 moves upward and pulls up the transportation tank 30 through the drive element 253 to the first position P1. The electric power generation process of the electric motor 52 driven by the solid particles S is similar to the previous embodiment, and the descriptions are omitted herein.

Referring to FIG. 7B, approaching low tide, the floating body 10 moves down and the transportation tank 30 descends down to the second position P2 through the drive element 253 so as to retrieve the solid particles S. The functions of the lower container 60 are the same as in the previous embodiment, and the descriptions are omitted herein.

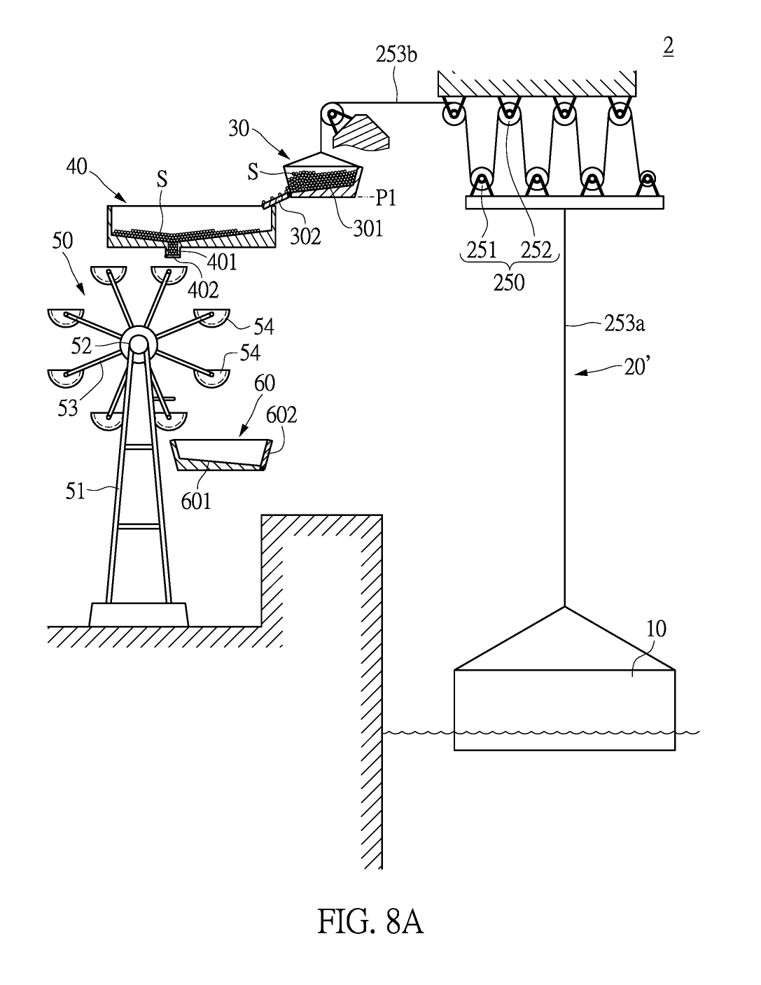

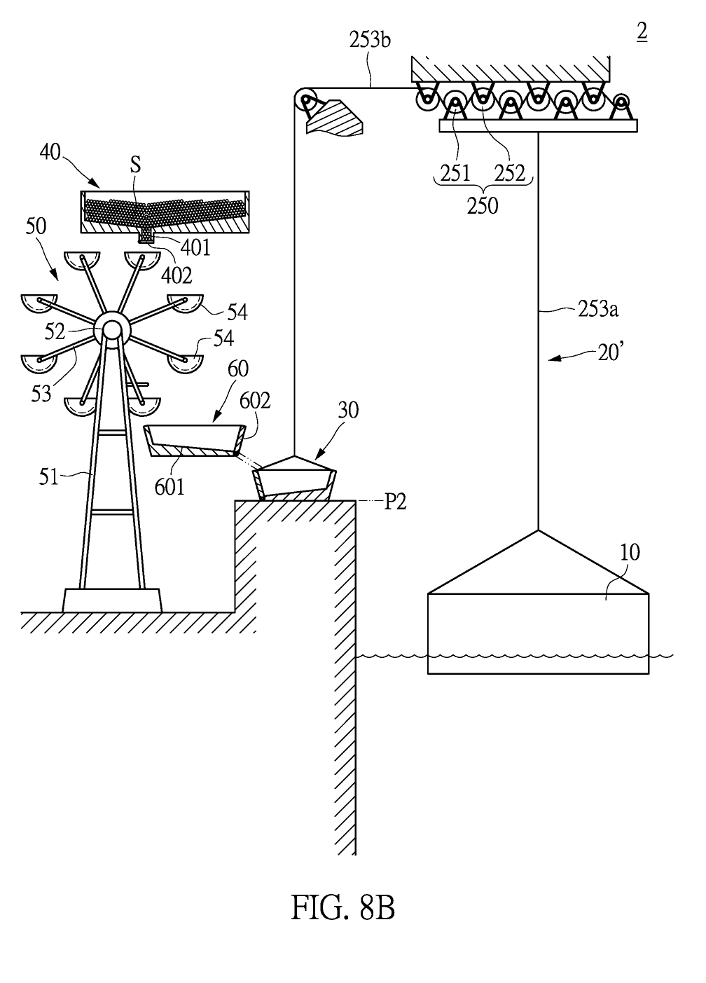

Please refer to FIG. 8A and FIG. 8B. FIG. 8A is a schematic diagram of a power generation system at low tide according to another embodiment of the instant disclosure, and FIG. 8B is a schematic diagram of the power generation system shown in FIG. 8A at high tide according to the embodiment of the instant disclosure. In the instant embodiment, the transmission device 20′ also includes a pulley assembly 250 and at least one driving unit.

The driving unit includes two hanging members 253a, 253b, and the pulley assembly 250 includes a plurality of pulleys. One of the hanging members 253a is connected between the floating body 10 and the pulley assembly 250, and the other hanging member 253b is wound around the pulleys and connected to the transportation tank 30.

In the instant embodiment, the pulley assembly 250 also includes a plurality of movable pulleys 251 and a plurality of fixed pulleys 252. However, the arrangements of the movable and fixed pulleys 251, 252 are different from those shown in FIG. 7A. Specifically, as shown in FIG. 8A, the floating body 10 is suspended under the pulley assembly 250 through the hanging member 253a.

Approaching low tide, the movable pulleys 251 are pulled down by the tidal force and the gravity of the floating body 10 through the hanging member 253a. Meanwhile, the transportation tank 30 is pulled up through the hanging member 253b to the first position P1 due to the descent of the movable pulleys 251

Please refer to FIG. 8B. Approaching high tide, the floating body 10 moves upward due to the tidal force so that the movable pulleys 251 are raised and the transportation tank 30 descends down to the second position P2 through the hanging member 253b.

Although two hanging members 253a, 253b are used in the present embodiment, the same result can be achieved by using only one hanging member. In addition, the driving unit can include a driving lever, gear, belt or the other well-known elements.

According to the abovementioned embodiments, as long as the transmission device can drive the transportation tank to be lifted up to the first position P1 approaching the high or low tide period, the structure or elements of the transmission device are not limited to the embodiments provided herein, and other means also can be used according to actual demands.

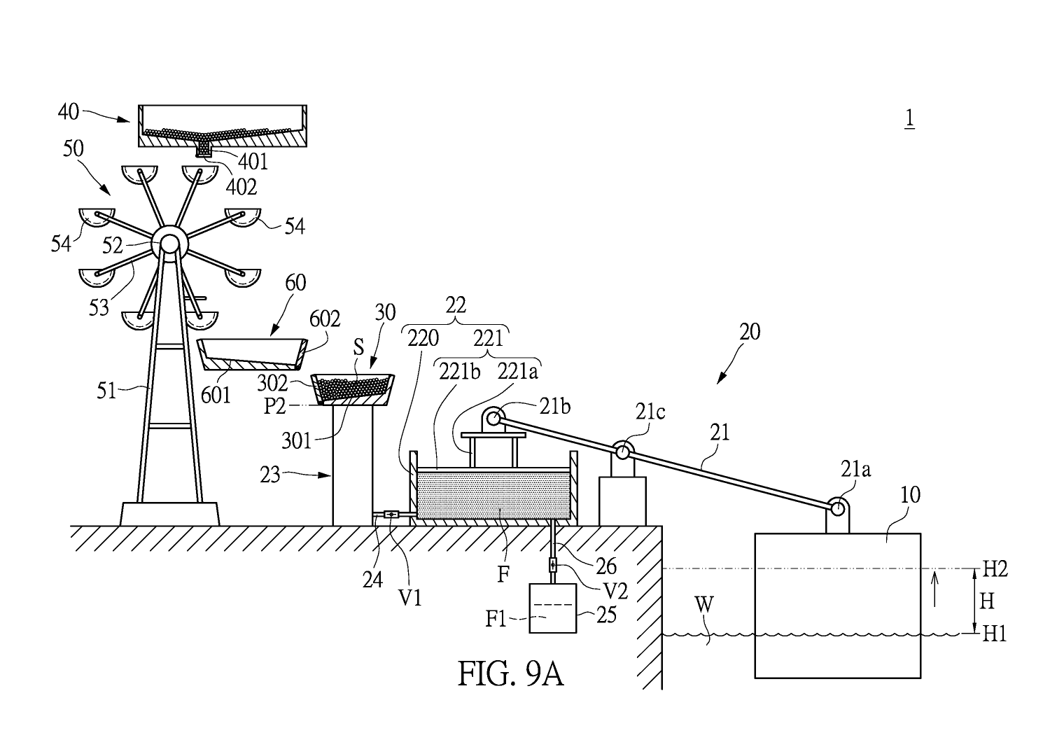

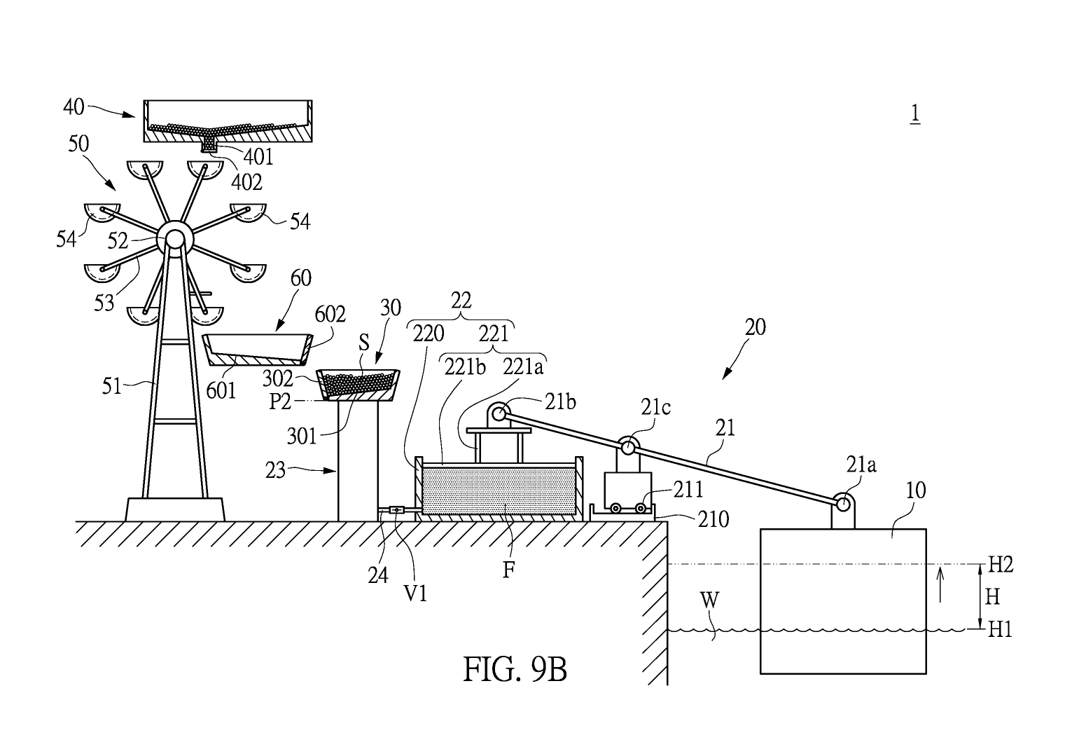

Please refer to FIG. 9A, which is a schematic diagram of a power generation system according to another embodiment of the instant disclosure. The operation theory of the embodiment shown in FIG. 9A is substantially similar to that of the embodiment shown in FIG. 1A. However, the value of the tidal difference H varies with different locations or different cycle periods. Accordingly, the transmission device 20 further includes a temporary reservoir 25, which allows the amount of the working fluid F in the first reservoir 220 to be adjustable. As such, the movement distance of the first piston 221 can be maintained within a preset range, thereby controlling the lifting height of the second piston 231. The temporary reservoir 25 is in fluid communication with the first reservoir 220 through a connection pipe 26, and an adjusting valve V2 is used to adjust the amounts of the working fluid F respectively in the first reservoir 221 and in the temporary reservoir 25.

Furthermore, please refer to FIG. 9B, which is a schematic diagram of the power generation system according to the embodiment of the instant disclosure. In the embodiment shown in FIG. 9B, the pivot point 21c of the lever 21 is movably disposed between the first end 21a and the second end 21b so that the movement distance of the first piston 221 can be maintained within the preset range. Specifically, the pivot point 21c can be disposed on a rail 210 through automatic wheels 211. By adjusting the position of the pivot point 21c, the impact, which results from the different tidal differences H at different locations, on the movement distance of the first piston 221 can be attenuated. The moving distance of the previously mentioned automatic wheels 211 can be controlled by a control unit according to the variation of the tidal difference H. Additionally, the pivot point 21c can be movably disposed between the first and second ends 21a, 21b by other means.

In the power generation system provided in the instant disclosure, the tidal force or the buoyant force is converted to the potential energy of the solid particles through the floating body and the transmission device, and the pull of gravity on the solid particles is used to drive the power generator unit to generate electric power. As such, the power generation system provided in the instant disclosure can supply steady and environmentally friendly electric power by using the green energy.

In the power generation system provided in the instant disclosure, the height position of the floating body can be varied due to the tidal force or the buoyant force so that the transmission device is driven to convert the tidal force or the buoyant force to the potential energy of the solid particles. Thereafter, the pull of gravity on the solid particles can be used to drive the electric motor of the power generator unit to rotate and generate electric power. As such, the power generation system provided in the instant disclosure can supply steady and environmentally friendly electric power and not affected seriously by environmental factors, such as season or weather.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A power generation system comprising:
a floating body for floating on the sea, wherein the floating body is driven by a tidal force to move upward or downward;
a transmission device connected to the floating body and driven by a movement of the floating body;
a transportation tank for transporting a plurality of solid particles linked up with the transmission device;
an upper container arranged adjacent to a first position, wherein when the floating body moves upward or downward, the transmission device is driven to lift the transportation tank up to the first position so that the solid particles are transported to and stored in the upper container, or the transmission device is driven to lower the transportation tank down to a second position to receive the solid particles; and
a power generator unit arranged under the upper container, wherein when the upper container releases the solid particles stored therein, the power generator unit is driven to generate electric power.

2. The power generation system according to claim 1, wherein the transmission device comprises:
a first hydraulic unit including a first reservoir for storing a working fluid, a first piston arranged in the first reservoir;
a second hydraulic unit including a second reservoir and a second piston arranged in the second reservoir;
a connecting pipe, wherein the second reservoir is in fluid communication with the first reservoir through the connecting pipe; and
a lever having two opposite ends, one end is movably connected to the floating body, and the other end is pivotally connected to the first piston, wherein when the floating body moves upward, the lever pushes the first piston down so as to squeeze the working fluid in the first reservoir into the second reservoir and push up the second piston.

3. The power generation system according to claim 2, wherein the transmission device further includes a control valve disposed on the connecting pipe to control the flow of the working fluid between the first reservoir and the second reservoir.

4. The power generation system according to claim 2, wherein the transmission device further comprises a temporary reservoir in fluid communication with the first reservoir to adjust the amount of the working fluid in the first reservoir.

5. The power generation system according to claim 2, wherein the transmission device further comprises a rail, and the lever includes a pivot point movably disposed on the rail to adjust a movement distance of the first piston.

6. The power generation system according to claim 1, wherein the transmission device comprises:
a pulley assembly including a plurality of pulleys; and
a drive element connected between the transportation tank and the floating body, wherein the drive element is arranged to revolve around the pulleys.

7. The power generation system according to claim 1, wherein the transportation tank includes an inclined bottom and an active gate facing the upper container.

8. The power generation system according to claim 1, wherein the power generator unit comprises:
an electric motor, wherein an elevation position of the electric motor with respect to a ground level is higher than the second position;
a plurality of arms connected to the electric motor; and
a plurality of cup-shaped blades, wherein the cup-shaped blades are respectively connected to ends of the arms;
when the solid particles are poured into each of the cup-shaped blades from the upper container, the cup-shaped blades drive the electric motor to rotate through the corresponding arms.

9. The power generation system according to claim 8, further comprising a lower container, wherein an elevation position of the lower container with respect to the ground level is lower than that of the electric motor to recycle the solid particles carried by the cup-shaped blades, and the elevation position of the lower container is higher than the second position to transport the solid particles to the transportation tank when the transportation tank is lowered down to the second position.

10. The power generation system according to claim 8, wherein the lower container includes a sloping bottom surface and a movable gate facing the transportation tank.

11. The power generation system according to claim 8, wherein the upper container comprises a discharge opening arranged at a bottom thereof and a movable door, the movable door is intermittently opened and closed so that the solid particles are carried on each of the cup-shaped blades sequentially passing below the discharge opening.

12. A power generation system comprising:
a floating body for floating on the water, wherein the floating body is driven by a buoyant force to move upward or downward;
a transmission device connected to the floating body and driven by a movement of the floating body;
a transportation tank for transporting a plurality of solid particles linked up with the transmission device;
an upper container arranged adjacent to a first position, wherein when the floating body moves upward or downward, the transmission device is driven to lift the transportation tank up to the first position so that the solid particles are transported to and stored in the upper container, or the transmission device is driven to lower the transportation tank down to a second position to receive the solid particles; and
a power generator unit arranged under the upper container, wherein when the upper container releases the solid particles stored therein, the power generator unit is driven to generate electric power.
